(19) United States
(12) Patent Application Publication
(10) Pub. No.: US 2016/0048933 A1
(43) Pub. Date: Feb. 18, 2016

(54) RESERVOIR PROPERTY TREND MODELING GUIDANCE USING DATA-DRIVEN UNCERTAINTY RANGE

(71) Applicant: Chevron U.S.A., Inc., San Ramon, CA (US)

(72) Inventors: Sebastien Strebelle, San Francisco, CA (US); Michael Pyrcz, Humble, TX (US); Chris Ainley, Houston, CA (US); Julian Thorne, Houston, TX (US)

(21) Appl. No.: 14/461,212

(22) Filed: Aug. 15, 2014

(51) Int. Cl. G06Q 50/16; G06Q 10/06; G06Q 30/02

(52) U.S. Cl. CPC G06Q 50/16; G06Q 30/0206; G06Q 10/067

(57) ABSTRACT

Methods and systems for trend modeling of subsurface properties are disclosed. One method includes defining a stratigraphic grid of a subsurface volume, the stratigraphic grid including a plurality of columns and a plurality of layers. The method further includes determining, for each layer or column, an initial average property value based at least in part on well data in the subsurface volume and a confidence interval around that initial average property value defining a range of likely values for a target average property value. The method also includes receiving one or more user-defined edits to the initial average property value in one or more of the layers or columns, the one or more edits resulting in the modeled target average property value, and determining whether the modeled target average property value falls within the confidence interval.

### TECHNICAL FIELD

The present disclosure relates generally to computer-based modeling of physical properties. In particular, the present disclosure relates to computer-based trend modeling of reservoir properties using uncertainty ranges based on known data.

### BACKGROUND

The objective of geological reservoir modeling is to build 3D models of petrophysical properties (typically types of sediment formations, as well as properties of such formations such as porosity, and permeability, and sometimes water saturation) that reservoir engineers can use to run flow simulation, forecast future hydrocarbon production and ultimate recovery, and design well development plans. In most geological environments, especially in clastic environments, porosity and permeability heterogeneity is primarily driven by facies depositional events. As such, porosity and permeability distributions can be mainly characterized through the geometry and spatial distribution of facies geobodies, for example sinuous sand channels. Therefore geomodelers very often first build 3D facies models (depositional facies, and sometimes lithofacies), and then populate porosity and permeability values within those models.

3D geomodels are usually built in 3D stratigraphic grids generated from a structural and stratigraphic framework, i.e. a set of interpreted faults and stratigraphic horizons. Various sources of information are used by geomodelers to build facies and petrophysical property models, including core and well log data, as well as seismic and dynamic data when available. In addition to actual reservoir data, geomodelers may borrow information from reservoir analogues, e.g., more mature reservoirs (that have more well-known characteristics) that are expected to have characteristics and features similar to the reservoir to be modeled. The selection of analogues is a highly subjective decision from geomodelers, based on their interpretation of actual reservoir data (mainly core and seismic data), and their experience with similar reservoirs. Even though such selection is very subjective, the information borrowed from analogues by geomodelers is critical in reservoirs with sparse well data, because it represents the best data available to predict facies and petrophysical properties between wells, and away from wells.

Numerous methods are available to build facies or petrophysical property models. Typically, such methods require target facies proportions and target property histograms for various properties, which may be derived from well data and adjusted for bias based on a preference to drill in areas with high porosity and/or permeability. Such methods further require a model of facies or property continuity or correlation. This can be determined from a variogram model inferred from well data or training image based on an analogous subsurface area. Finally, such methods may also optionally require trend models to control spatial distribution of facies or porosity/permeability values.

In the case of continuous properties, which are properties that take any value from among a range of values, for example porosity, which may take any value along a continuum from 0-100%, the most common types of trend models are 1D property trend curves and 2D property trend maps. Property trend curves provide a target average property value that the modeling method should try to honor in each layer of a grid of columns and layers in which a model is to be built. In each grid layer, that target average property value can be initialized as the average value of well data present in the layer, and then edited by the modeler to address limited well data. Furthermore, property trend maps provide a target average property value that the modeling method should try to honor along each column of a grid in which a model is to be built. In each column, that target average property value can be initialized as the average value of well data present in the column, or, if such well data is not present in the column, can be based on an interpolated average value based on previously computed columns, such as those columns including well data. This interpolation can be based, for example, on inverse distance or a kriging computation. A user, typically a geomodeler, can then edit that initial property trend map computed from well data, particularly in areas away from well data.

In the case of discrete properties, which are properties that have a state selected from among a plurality of discrete states, for example facies, where the facies values could be selected from among sand and shale, the most common types of trend models are 1D facies proportion curves and 2D facies proportion maps. Facies proportion curves provide target facies proportion values that the modeling method should try to honor in each layer of the modeling grid, whereas facies proportion maps provide target facies proportion values that the modeling method should try to honor in each column of the modeling grid. Initial facies proportion maps and curves can be computed from well data, and then edited to include additional information such as seismic data or user's geological interpretation.

The editing, by geomodelers, of initial trend maps or trend curves initially computed from well data is highly subjective, and highly uncertain. To represent that uncertainty, users of modeling software may build several maps or curves representing alternative geological scenarios (e.g. two alternative trend curves to account, or not, for the presence of a user-interpreted shale layer). Low/mid/high case scenarios (sometimes called P10/P50/P90 scenarios) are typically developed to represent different reservoir global facies proportion estimations or different reservoir property average estimations, or to illustrate different reservoir interpretations.

In current practice, no quality control process is performed on edited trend curves or maps to check their consistency with well data. However, any such edited trend curves or maps that are inconsistent with actual well data may lead to unrealistic facies or petrophysical property models, since they depart from the known facies data in at least some locations. Because hydrocarbon harvesting performance is highly dependent upon the subsurface sediment type, such unrealistic modeling can result in poor performance forecasting for hydrocarbon harvesting from particular locations within the reservoir.

For these and other reasons, improvements in subsurface modeling techniques are desirable.

### SUMMARY

In summary, the present disclosure relates to generation of confidence intervals associated with an initial trend model computed from known data (typically well log data) to provide guidance to users of modeling software when editing such an initial trend model. In some aspects, the confidence intervals can be used to alert such users if edited trend model values are outside of such confidence intervals.

In a first aspect, a method for trend modeling of subsurface properties is disclosed. One method includes defining a stratigraphic grid of a subsurface volume, the stratigraphic grid including a plurality of columns and a plurality of layers. In the case of a trend curve, the method further includes computing an initial average property value from the known data (typically the well data) in each of the plurality of layers for the property to be modeled. The method further includes calculating a confidence interval around that initial average property value defining a range of likely values for a target average property value in each layer. The method also includes receiving one or more edits to the initial average property value in at least some of the plurality of layers, the one or more edits resulting in the modeled target average property value in each layer, and determining whether that modeled target average property value falls within the confidence interval. In the case of a trend map, the method further includes computing an initial average property value from the known data in each column of the stratigraphic grid for the property to be modeled. The method further includes calculating a confidence interval around that initial average property value defining a range of likely values for the target average property value in each column. The method also includes receiving one or more edits to the initial average property value in one or more of the plurality of columns, the one or more edits resulting in a modeled target average property value in each column, and determining whether that modeled target average property value falls within the confidence interval.

In a second aspect, a system for trend modeling of subsurface properties is disclosed. The system includes a computing system including a processing unit and a memory communicatively connected to the processing unit. The system also includes a modeling application stored in memory and defining a stratigraphic grid of a subsurface volume, the stratigraphic grid including a plurality of columns and a plurality of layers. The modeling application is configured to, when executed, determine an initial average property value in each layer or each column of the stratigraphic grid for the property to be modeled along with a confidence interval around that average property value defining a range of likely values for a target average property value in each layer or column. The modeling application is further configured to, when executed, receive one or more edits to the initial average property value in one or more of the layers or columns of the subsurface volume by a user, the one or more edits resulting in the modeled target average property value in each layer or column and determine whether that modeled target average property value falls within the confidence interval.

In a third aspect, a computer-readable storage medium including computer-executable instructions stored thereon is disclosed which, when executed by a computing system, cause the computing system to perform a method for trend modeling of subsurface properties. The method includes defining a stratigraphic grid of a subsurface volume, the stratigraphic grid including a plurality of columns and a plurality of layers. The method further includes determining, for each layer or column, an initial average property value based at least in part on well data in the subsurface volume and a confidence interval around that initial average property value defining a range of likely values for a target average property value. The method also includes receiving one or more user-defined edits to the initial average property value in one or more of the layers or columns, the one or more edits resulting in the modeled target average property value, and determining whether that modeled target average property value falls within the confidence interval.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a flowchart of a method for trend modeling of subsurface properties, according to an example embodiment of the present disclosure;

FIG. 2 illustrates a computing system useable to implement a system for trend modeling of subsurface properties, according to an example embodiment of the present disclosure;

FIG. 3 illustrates a stratigraphic grid of a subsurface volume for which a model is developed using the methods and systems of the present disclosure;

FIG. 4 illustrates a simulation of a property model in the subsurface model developed using modeling software as discussed herein;

FIG. 5 illustrates computation of a facies proportion curve from well logs, the facies proportion curve defining a facies proportion in each of a plurality of layers according to example embodiments;

FIG. 6 illustrates use of a facies proportion curve to impose constraints on facies proportions at each layer of a model;

FIG. 7 illustrates receipt of user edits to a facies proportion curve, including display of the position of modeled target facies proportions relative to their confidence intervals;

FIG. 8 illustrates computation of a facies proportion map from well logs, including areas of the model volume lacking well data;

FIG. 9 illustrates use of a facies proportion map to impose constraints on facies proportions along each column of a model;

FIG. 10 illustrates receipt of user edits to a trend map, including display of the position of modeled target average property values relative to their confidence intervals; and

FIG. 11 illustrates a example user interface displaying boundaries of the confidence interval computed for a trend curve, according to an example embodiment.

### DETAILED DESCRIPTION

As briefly described above, embodiments of the present disclosure are directed to methods and systems for providing guidance to users of modeling software for subsurface features, to maintain consistency of trend models with observed data. In some aspects, the present disclosure incorporates a computed confidence interval for target average property values based on well data or other known data, and providing guidance to users of modeling software based on whether modeled target average property values fall within the confidence interval.

In accordance with the present disclosure, the use of such guidance in assisting modelers ensures that modelers are aware of departures from likely ranges for target average property values, and as such can make a conscious choice as to whether such departures should be maintained, or whether additional changes to the trend model should be made to ensure that modeled target average property values remain within the confidence interval for that property. In particular embodiments, such properties can include petrophysical properties such as porosity, or facies present in the subsurface volume being modeled, which results in improved prediction regarding the potential presence of hydrocarbons to be harvested.

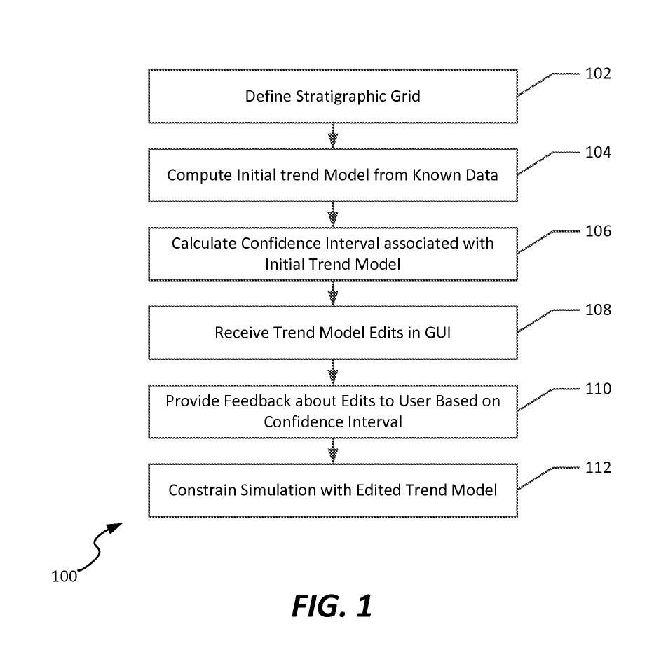

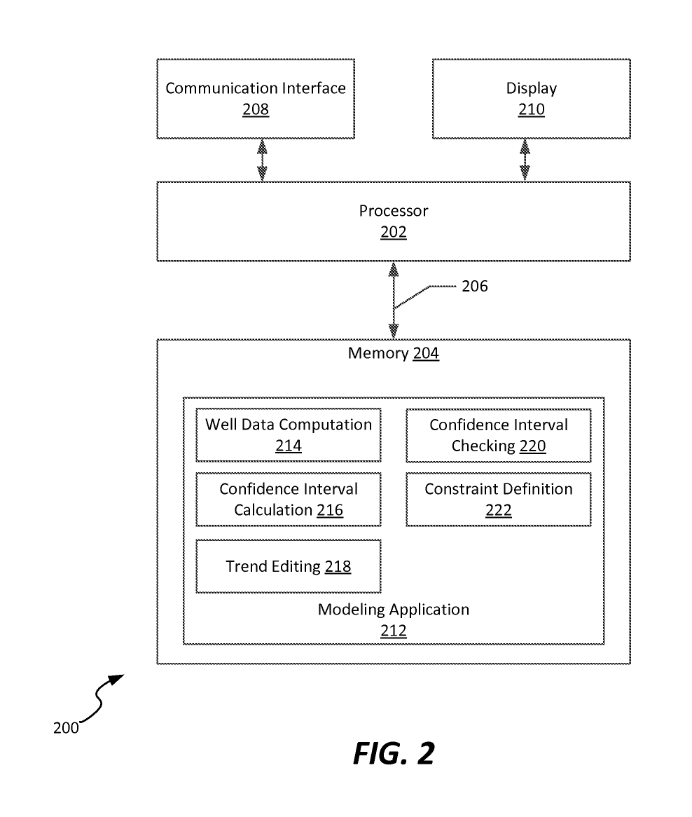

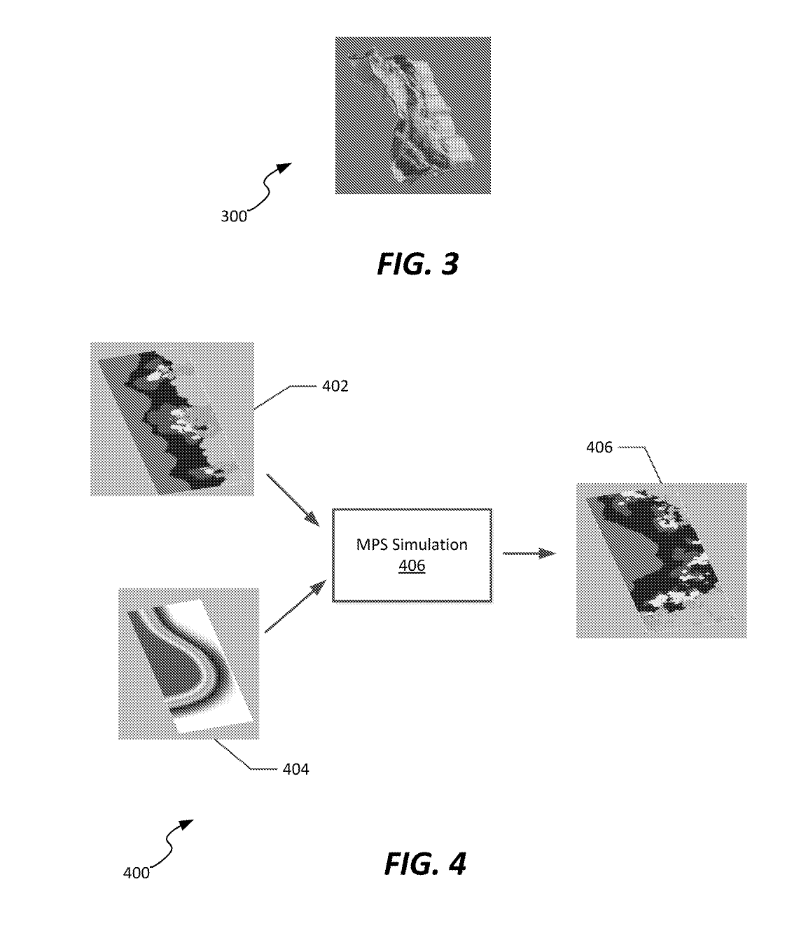

Referring now to FIG. 1, a flowchart of a general method 100 for trend modeling of subsurface properties, utilizing such guidance is shown. The method 100 can be performed by a computing system, such as the general computing system of FIG. 2, to perform one or more analyses and modeling tasks as described in further detail below in connection with FIGS. 3-11.

In the embodiment shown, the method 100 includes a definition operation 102, which defines a stratigraphic grid corresponding to the subsurface volume to be modeled. The definition operation 102 can define a stratigraphic grid including plurality of layers and a corresponding plurality of columns of a predetermined or varying size. A stratigraphic grid corresponds generally to a three-dimensional representation of a particular volume of interest, as depicted in FIG. 3.

A computation operation 104 builds an initial trend model from existing well data or other data associated with the subsurface volume to be modeled.

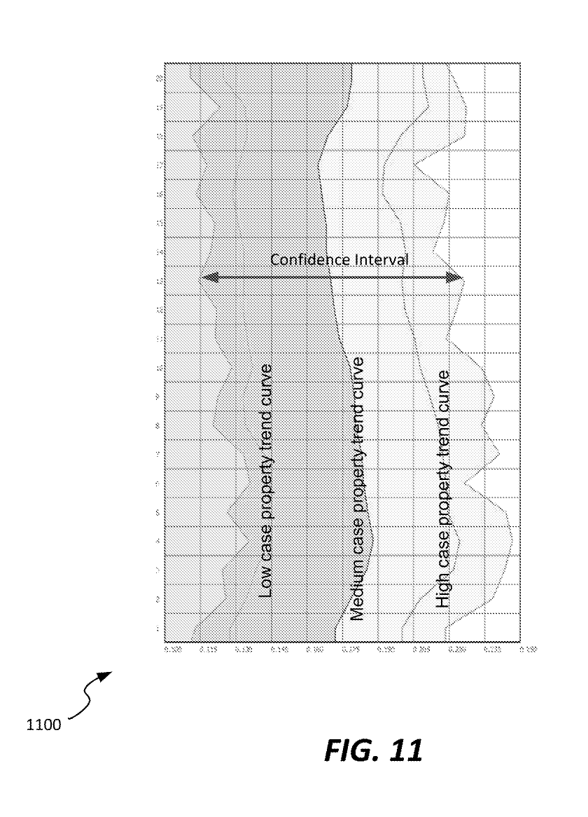

In some embodiments, the computation operation 104 generates an average property value in each layer or column of the stratigraphic grid. As noted above, in some instances, the modeled properties may be discrete properties that have a state selected from among a plurality of discrete states. Example discrete properties may be facies, where the facies values could be selected for example from among sand and shale. In such cases, a trend model will consist of target facies proportions that are to be honored in the facies model. In other instances, the properties being modeled may be continuous properties that may take any value from among a range of values. Porosity represents an example of continuous property as porosity may take any value along a continuum from 0-100%. In such cases, a trend model will include target average property values that are to be honored in the property model. A confidence interval calculation operation 106 generates a confidence interval around each of the average property values initially computed during computation operation 104. The confidence interval can be used during the trend modeling process to determine when or if a geomodeler (e.g., a user of a modeling software application) selects unlikely target average property values in one or more layers or columns of the stratigraphic grid. In example embodiments, a confidence interval can be calculated using P10 and P90 target average property values estimated in each individual layer or column. This corresponds to the 80% most likely values for the target average property value to be modeled. As discussed further below, if a modeler opts a model that results in a target average property value outside of the confidence interval, in some embodiments the modeler may be required (or suggested) to provide an explanation of why a trend model having a “less likely” value was selected. An example illustrating use of a property trend curve to develop a confidence interval in a particular layer is described in further detail below in connection with FIG. 11.

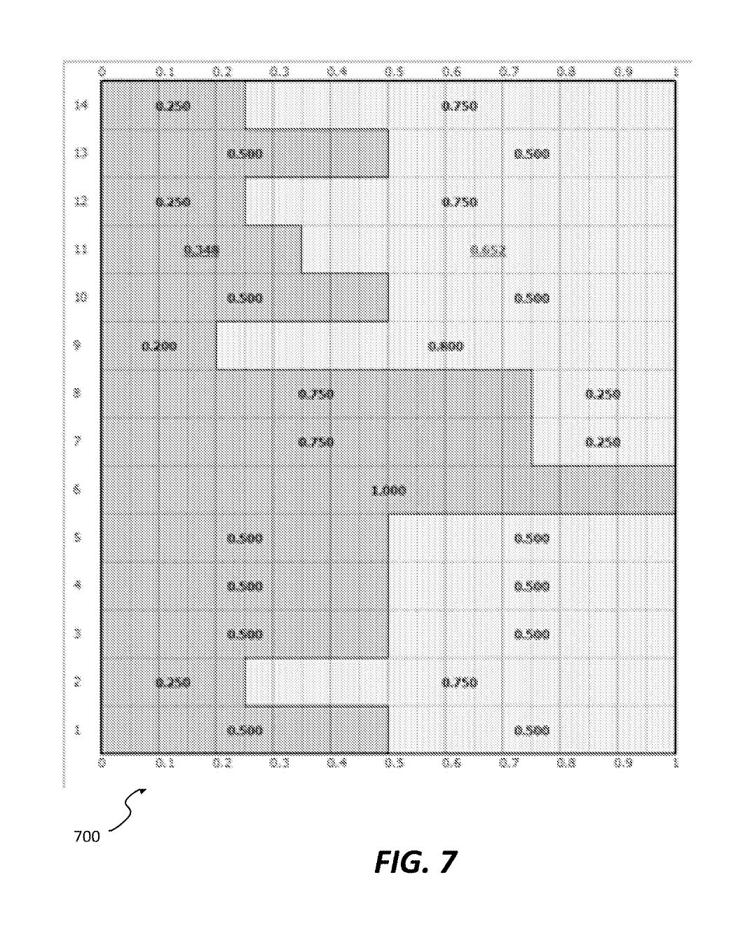

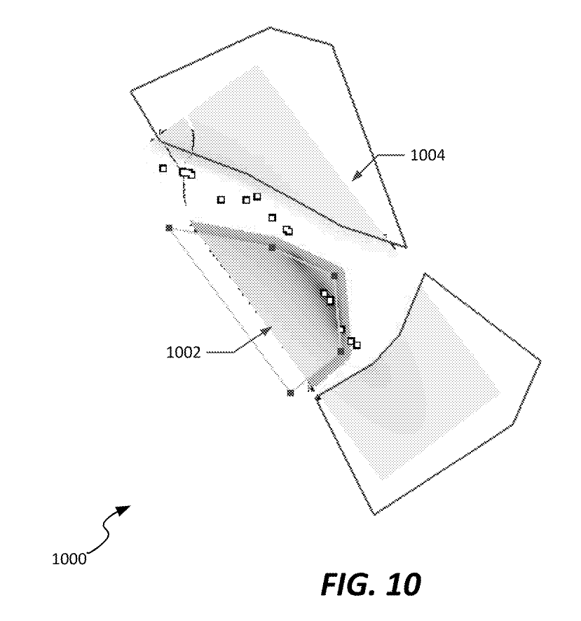

A model editing operation 108 receives an edit to the initial trend model from a modeler. This can include, for example, increasing or decreasing the target proportion of a particular facies at a particular location within the model. The edits made by the user can be made, for example, in a trend map or trend curve. A feedback operation 110 presents to the modeler one or more indications of whether the selected edit to the initial trend model results in a modeled target average property value to fall outside of an expected range for that property. For example, in cases where porosity is high at a particular level, it may be likely that a greater proportion of sand than shale is present. Accordingly, the modeler may increase the target sand proportion at that level. To the extent a modeler opts to model a large proportion of shale at that particular level, the feedback operation 110 may indicate to the modeler that their model departs from expected target average property values, and requests a reason for such departure. Example feedback is illustrated in FIGS. 7 and 10, described below.

A constraint operation 112 constrains simulation of property models on the stratigraphic grid using an edited trend model. This can correspond to, for example, constraining simulation on one or both of a trend map and a trend curve. In the case of discrete properties, the simulation method can include, for example, Multiple-Point Statistics (MPS) simulation, in which case a training image such as shown in FIG. 4, derived by a user of modeling software from analogous locations, can be built to model spatial continuity of the facies, while using a facies proportion map to control spatial distribution of facies within the volume modeled. In the case of continuous properties, a Sequential Gaussian Simulation (SGS) method can be used.

It is further noted that, although MPS simulation and SGS simulation are discussed above, other types of simulation may be used to build a property model constrained by a trend model. Accordingly, the present disclosure is not limited to such MPS or SGS simulation, but could relate to any simulation mechanism by which a trend model is used to control the spatial distribution of model values of discrete or continuous properties throughout a volume.

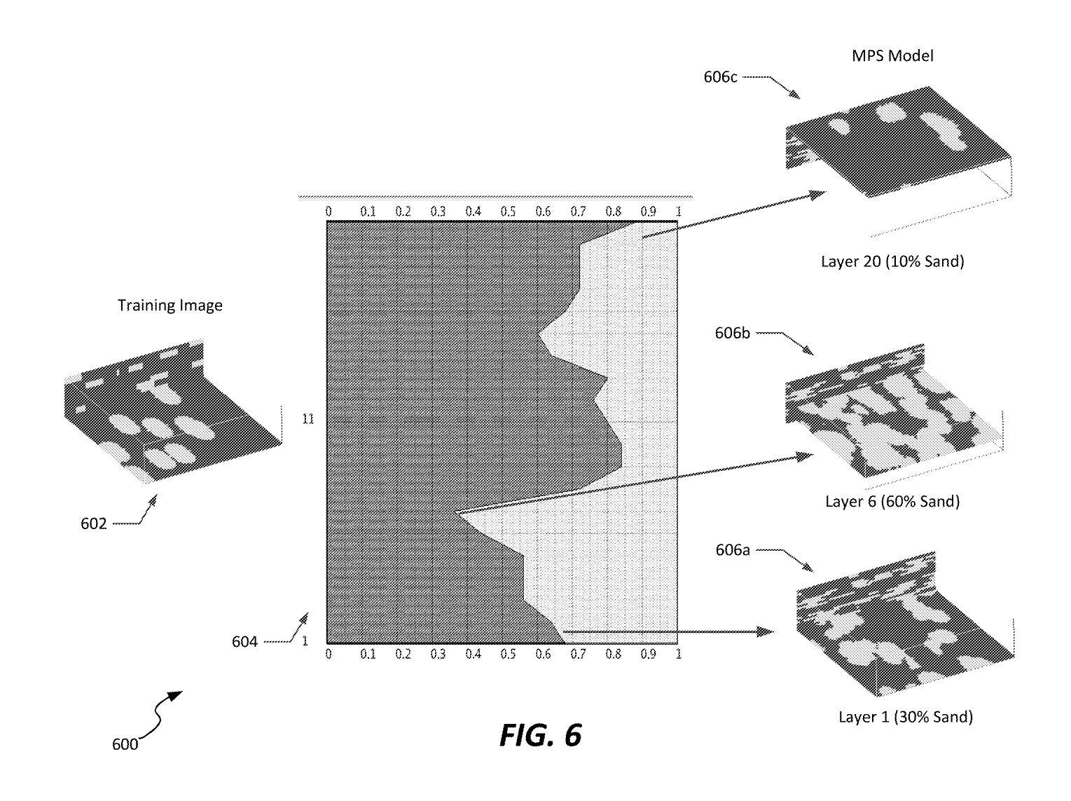

For example, the constraint operation 112 can use a facies proportion curve to constrain a MPS simulation to honor target facies proportions in each layer of the facies model. An example of application of a facies proportion curve constraint at each of a plurality of layers is illustrated in FIG. 6, and is discussed in further detail below.

Referring to FIG. 1 generally, it is noted that because, in each layer or column within the stratigraphic grid, a confidence interval is compared to the target average property value determined by the user, the resulting trend model will more likely be accurate or represent reasonable trend values, since the modeler must justify departures from the confidence interval. Furthermore, although in example embodiments, P10 and P90 values are used, in alternative embodiments; other confidence intervals could be defined, for example using P1 and P99 values. In such cases, a much more substantial explanation may be required of a modeler outside of that range, since it is very unlikely that such an average property value would occur (e.g., <2% of the time). In other example embodiments, other confidence intervals could be used, resulting in a more or less stringent set of values and requiring more or less explanation of a reason for departure from the range of expected values that surrounds the initial average property value.

It is noted that in various embodiments of the present disclosure, use of a trend model to constrain the spatial distribution of property values within a model can be accomplished in a number of ways. For example, when building a 3D property model, the user can use a trend map, or a trend curve, or both. The trend map will control the spatial distribution of property values along the horizontal, while a trend curve will control the spatial distribution of property values along the vertical. When both a trend map and a trend curve are used, those aspects can be combined into a three-dimensional trend cube, or probability cube (in the case of discrete properties such as facies).

It is further noted that although above the terms trend curve or trend map are used, such terms are intended to encompass trend maps or curves of either continuous properties, such as porosity and permeability, or discrete properties, such as facies. To the extent such discrete properties are referred to specifically, such curves can instead be referred to herein as a proportion curve or proportion map.

Referring now to FIG. 2 a schematic block diagram of a computing system 200 is shown. The computing system 200 can be, in some embodiments, used to implement a trend modeling system according to the present disclosure in which guidance regarding edited trend values can be provided. In general, the computing system 200 includes a processor 202 communicatively connected to a memory 204 via a data bus 206. The processor 202 can be any of a variety of types of programmable circuits capable of executing computer-readable instructions to perform various tasks, such as mathematical and communication tasks.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory 204 stores a trend modeling application 212, discussed in further detail below. The computing system 200 can also include a communication interface 208 configured to receive and transmit data, for example well data or other real world data required for modeling purposes. Additionally, a display 210 can be used for presenting the modeling graphics, or allowing a user to define model parameters for a subsurface volume.

In the embodiment shown, the trend modeling application 212 includes an initial trend computation from well data component 214, a confidence interval calculation component 216, a trend editing component 218, a confidence interval checking component 220, and a constraint definition component 222.

The initial computation component 214 presents to a modeling user a user interface (e.g., via display 210) on which that user can compute initial average property values from well data in each layer or column of the stratigraphic grid representing the subsurface volume to be modeled. The initial computation component 214 allows the user to compute initial trend curves or maps for properties such as facies, porosity, or other types of discrete or continuous properties of a subsurface volume, and presents feedback to the user in the form of a graphical display representative of outputs from the various other components 216-222.

The confidence interval calculation component 216 can, in embodiments, determine a confidence interval around each initial average property value. The confidence interval can, as noted above, correspond to an interval of likely values for target average property values in each layer or column of a stratigraphic grid. In example implementations, a typical 80% of values can be defined as representing a confidence interval, bounded by P10 and P90 data values. Of course, other sizes of confidence intervals could be used as well, and can be provided to the modeling component for feedback to a user to indicate whether modifications to the initial trend model by a user results in target average property values outside of a likely range of values.

The trend editing component 218 can, in embodiments, allow the user to determine target average property values in each layer or column of a stratigraphic grid by editing initial values computed from well data using the initial computation component 214.

The confidence interval checking component 220 checks if a target average property value determined by the user in a particular layer or column falls within the confidence interval calculated for that layer or column,

The constraint definition component 222 can be used to impose, for each area (e.g., each column and/or layer) within the volume, a target average property value. For example, the constraint definition component can, in some embodiments, be used to honor a facies proportion curve, or a facies proportion map.

Referring now to FIGS. 3-11, various additional details are described regarding operation and use of the methods and systems described above regarding FIGS. 1-2. In particular, the additional details in FIGS. 3-11 represent a particular implementation in which initial trend models computed from well data are edited and feedback is provided to the user regarding ranges of likely values for target average property values in each layer or column of the Stratigraphic grid

Referring specifically to FIG. 3, a stratigraphic grid 300 of a subsurface volume for which a model is developed is shown. In the embodiment shown, the stratigraphic grid 300 is used to develop a property model in a particular space that includes a plurality of layers and columns.

As seen in FIG. 4, a simulation 400 of a property model is shown. In this embodiment, a training image 402 and a facies proportion constraint 404 are provided to a Multiple-Point Statistics (MPS) simulation to generate a facies model 406. In example embodiments, the facies proportion constraint 404 can be one or both of a facies proportion curve and a facies proportion map.

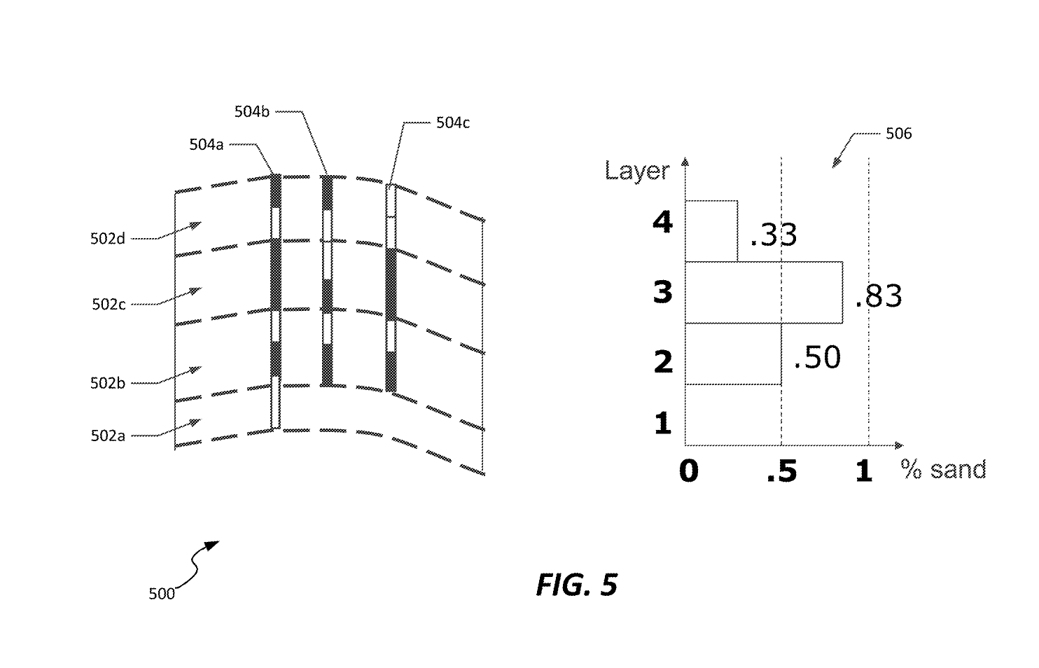

Referring to FIG. 5, an example illustration of computation of a facies proportion curve 500 is provided, in an example embodiment. In the embodiment shown, an initial facies proportion 506 is determined in each layer of the stratigraphic grid based on collected known well data. For example, in the specific example shown, four layers 502a-d are shown. In the example shown, in layer 1 502a, no sand (illustrated by way of a solid shaded bar) is shown; rather, only shale (outlined bar) in a first well site 504a is shown. Accordingly, facies proportion of sand in layer 1 502a is 0%. However, in layer 2 502b, the three well data sites 504a-c are shown as being 50% sand; as such, the overall facies proportion is 50% sand, 50% shale. Similarly, in layer 3 502c, 5/6, or 83%, represents sand, and in layer 4 502d, 2/6, or 33%, represents sand. A collected curve of such values represents the initial facies proportion curve 506 for this set of layers and well data.

Of course, if a continuous property were to be modeled, the corresponding initial property trend curve could be similarly generated from an average of the well data values in each layer. In any case, an initial property trend curve, for facies, porosity, or other properties, may be then edited by the geomodeler to compensate for the limited number of available well data. For example, the initial trend curve can be smoothed if deemed too heterogeneous, or it can be locally modified according to the geomodeler's geological interpretation (e.g., by adjusting for a likelihood of a decreasing porosity trend in lower layers due to compaction).

FIG. 6 provides a graphical display 600 of a facies proportion curve 604, and illustrates use of such facies proportion curve as a constraint in Multiple-Point Statistics (MPS) simulation. In particular, each layer of the MPS model reproduces sand geobody ellipsoidal patterns similar to those displayed by the training image 602 selected by a modeler for its analogous characteristics to those in the local area, and the proportion of sand is constrained at each layer by the target facies proportion provided by the facies proportion curve (shown in example layers 706a-c).

Extending the example facies proportion curve concept from FIG. 5, FIG. 7 illustrates how edited facies proportions can be checked against different confidence intervals, one per facies, in each layer k. Accordingly, in some embodiments the facies proportion values are displayed in a graphical interface 700 using different colors depending on their positions relative to their corresponding confidence intervals. For example, facies proportion values can be displayed as black (or white) if they fall within the confidence interval, blue is they are below the P10 values, and red if they are above the P90 values, as shown.

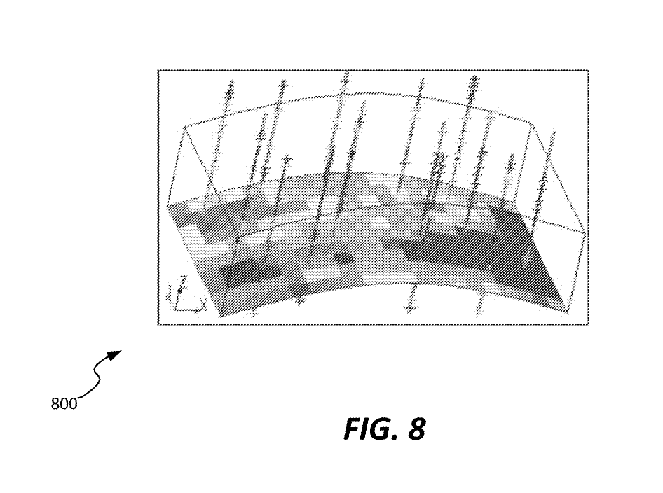

Referring to FIG. 8, an example facies proportion map 800 is provided as computed for two facies (sand and shale) from 13 wells in a particular volume. As an initial matter, and as indicated in FIG. 8, a facies proportion map 800 can be computed by first computing facies proportions from each well overall, and then interpolating those facies proportions between wells, to derive facies proportions in columns lacking well data. In particular, to calculate a facies proportion map, for any grid column (i, j) containing at least one well datum, the proportion of facies F at (i, j) can be initialized as the ratio between the number of well data interpreted as facies F in column (i, j) and the total number of well data in column (i, j). Then, the initial facies proportions in all remaining columns that do not contain any well log data can be interpolated/extrapolated from facies proportions previously computed in columns containing well log data using techniques such as inverse distance or some form of kriging or other interpolation technique.

As above regarding the proportion curve, a trend map could be generated for a property other than facies. For example, trend maps could be generated for porosity or permeability, or other continuous variables.

As seen in FIG. 8, an example facies proportion map 800 is provided as computed for two facies (sand and shale) from 13 wells in a particular volume. The initial facies proportion map defines a horizontal map representing facies proportions at each column (shown by differing shading or coloring in each column, including both columns including or lacking well data). For example, in the example shown, a shaded area to the upper left of the facies proportion map 800 represents a greater proportion of sand than shale, while a darker shaded area to the right of the facies proportion map represents a greater proportion of shale than sand. In particular embodiments, different colors could be used to represent different proportions (e.g., red representing a high proportion of sand, and blue representing a higher proportion of shale, with a gradient illustrated there between).

Once an initial facies proportion map is computed from well data, that facies proportion map can then be edited by the geomodeler to compensate for limited well data that may be available, in particular in areas away from well control. In such instances, secondary data, such as seismic data, or reservoir facies deposition interpretation, or other secondary data sources could be used to edit initial facies proportions.

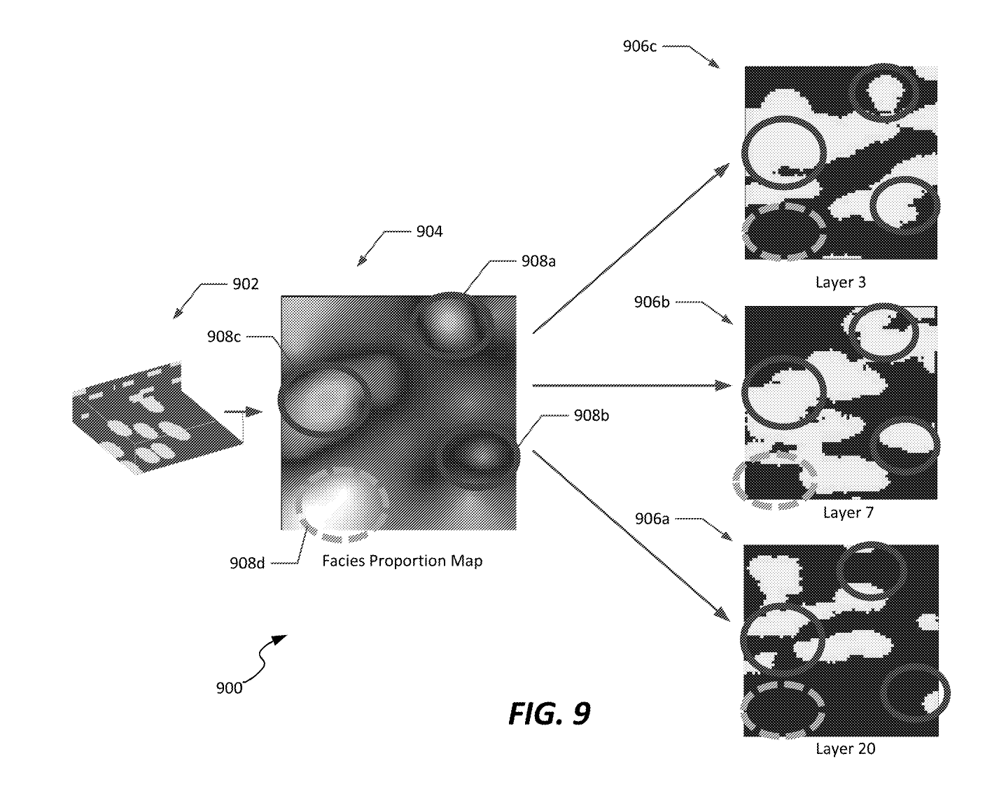

Once a facies proportion map is developed, it can be applied to control horizontal distribution of facies in an MPS model, as illustrated in FIG. 9. In that figure, a training image 902, again selected by a user as representative of the area of interest, may be constrained by a facies proportion map 904, which includes various facies proportions. Accordingly, the proportion of sand in each column of the MPS model is controlled by the target sand proportion provided by the facies proportion map at that column location. In the example shown, in each of three different layers shown (layers 3, 7, and 20), the facies are distributed such that areas of relatively higher sand proportions in the proportion map are honored. In the example shown, regions 908a-c, representing relatively higher proportions of sand, are preserved as locations of where sand proportions are likely higher (shown by the solid circles in layer maps 906a-c), while region 908d (shown by the dashed circle) represents a relatively higher proportion of shale and is preserved through the layers as likely shale.

FIG. 10 illustrates a graphical depiction presented in a user interface capable of displaying the effect of user edits to a trend map, including display of the effect of such user edits with respect to the confidence interval for the target property average value. In particular, the user interface 1000 displays a map that is generated using a color scale or other graphical feedback mechanism illustrating whether user edits by the geomodeler (shown as outline lines in the display) causes a departure of values from the confidence interval. In an example embodiment, a color scale can be depicted when used in connection with the editable trend curves, with 3 main colors: one color (e.g., blue) corresponding to low percentiles (referenced with surrounding line in region 1004), another color (e.g., white) corresponding to medium percentiles (in the 10-90 range), and a further color (e.g., red) corresponding to high percentiles (referenced with surrounding line and depicted as region 1002).

In the case of discrete properties such as facies, several percentile maps, one per facies, could be generated. Such percentile maps could be used, and would be similar to the percentile map computed for the property trend map displayed in FIG. 10. The geomodeler may also focus on one particular percentile map only, corresponding for example to the main reservoir facies, or on a subset of percentile maps. It would be also possible to compute a summary map that would simply shows areas where some edited facies proportions do not fall within their corresponding confidence intervals.

Typically, a geomodeler will smooth trend curves or maps initially computed from well data to remove small scale variability considered as a statistical artefact due to the limited number of well data. Such geomodelers may also model the trend curve or map using a parametric function, typically a linear trend model. When looking at the resulting percentile map, the geomodeler, or a reviewer, immediately sees areas where the trend map seems to be quite low or quite high compared to the well data, which may require some explanation from the geomodeler. Preferably, by editing trend maps in the user interface 1000, the geomodeler can maintain many values within the P10 and P90 range.

FIG. 11 illustrates a graph 1100 showing derivation of a confidence interval for a target average property value, according to an example embodiment. In the example shown, the confidence interval is derived for porosity; however, in alternative embodiments, other properties, such as permeability, could be determined as well. There are various ways to calculate a confidence interval for a target property. In some embodiments, a solution is to invoke the central limit theorem, and calculate the standard error from the values of all the well data used to compute the initial average property value. For example, in the case of a trend curve, if there 6 well data in layer k, with porosity values 0.18, 0.15, 0.22, 0.19, 0.16, and 0.19, then the average well data value is 0.182, with a standard deviation 0.0088. Therefore the standard error is 0.021, and using a t-student distribution, the P10-P90 confidence interval is 0.151-0.194. This means that, according to the well data, there is an 80% chance that the porosity average in layer k is between 0.151 and 0.194, only 10% chance that the porosity average is below 0.151, and 10% chance that it is above 0.194.

In alternative embodiments, although P10-P90 confidence ranges are commonly computed, geomodelers may decide to compute a more conservative P1-P99 range. In such cases, selecting values outside the confidence interval may require additional scrutiny or strong evidence that such departures would be justified.

In calculating a confidence interval, there are some particular cases in which such central limit theorem techniques may not be accurate. For example, in cases where wells are close to each other, the well data cannot be considered as independent. Declustering data techniques can be used to assign relative weights to each well datum as a function of its proximity to other well data. Such declustering weights should be accounted for to compute a weighted property average and corresponding standard deviation from the well data. Then an “equivalent” number of independent data can be estimated and used in the mathematical formulation of the standard error.

In still further embodiments, other statistical methods than the t-student distribution can be considered. For example, in presence of more than 30 well data per layer, a Gaussian distribution for the property average probability distribution can be used. Furthermore, it is noted that, when computing confidence intervals for facies proportions in layers where the average facies proportions computed from the well data are close to 0 or 1, a standard error method fails in such cases, and may be replaced by, for example, a Clopper-Pearson method.

In the examples shown, the confidence interval is determined for a trend curve or a trend map on a layer-by-layer or column-by-column basis, and represents a range of target average property values that are likely in a particular layer or column. In some example embodiments, a confidence interval is computed at any location (i, j), where i represents the column and j the layer for the particular property.

One optional arrangement for deriving a confidence interval consists in displaying an average value curve for a target property, which corresponds to the medium case proportion curve shown in FIG. 11. Additional curves, respectively corresponding to the P10 and P90 average values estimated in each individual layer, can also be depicted. These additional curves can be used as physical boundaries of the confidence interval and represent thresholds at which a geomodeler's editing may be indicated as outside of likely bounds for values.

It is noted that the proportion curve illustrated as used in FIG. 11 only provides a local P10 and P90 property trend values layer by layer; they globally cannot be used as a P10 or P90 property trend curve for the reservoir. Instead, one solution may be to compute a P10 and P90 global property average for an entire reservoir volume, and computing a constant percentile Pxx such that the property trend curve obtained from all the Pxx percentile values in each layer matches that P10 or P90 global property average. A similar method can be applied to estimate P10 or P90 trend maps, and P10 or P90 3D trend models.

For categorical properties, such as facies, a similar approach can be used for each category to guide user's editing. Computing a P10 or P90 trend curve/map/3D model, may require however an iterative process to ensure that categorical proportions add up to 1 for each simulation grid column/layer/cell.

Referring to FIGS. 1-11 generally, although the examples described herein illustrate a 1D trend curve or a 2D trend map, it is recognized that similar techniques could be used for 3D facies probability cubes or 3D property trend cubes. A 3D facies probability cube provides local facies probabilities in each cell of the 3D grid where the model is to be built; local facies probabilities can be used in variogram or training image-based programs to influence or control the 3D spatial distribution of facies. A 3D property trend cube provides a trend value in each cell of a 3D grid where the model is to be built; local trend values can be used in programs such as SGS with co-located co-kriging to influence and control the spatial distribution of low and high property values. Such 3D cubes can be derived from geological interpretation using, for example Facies Distribution Modeling, or by calibration of seismic data. It is also possible to compute an initial facies probability/property trend cube from well data using kriging, and estimate local confidence intervals from local kriging variances. Using such techniques, geomodelers can check the consistency of facies probability or property trend cubes versus local confidence intervals.

Alternatively, the facies probability cube can be column-wise averaged to produce a facies proportion map, or layer-wise averaged to produce a facies proportion curve, and the previous guidance techniques can be used to check the consistency of those facies proportion maps/curves with well data. Similarly, the property trend cube can be column-wise averaged to produce a property trend map, or layer-wise averaged to produce a property trend curve, and the previous guidance techniques can be used to check the consistency of those property trend maps/curves with well data.

Referring to FIGS. 1-11 generally, in some additional embodiments, for continuous properties, e.g. petrophysical properties (porosity, permeability), one solution to provide guidance to modelers when editing trend curves or maps computed from well data consists in providing local uncertainty ranges associated with computed trend values. In the case of the 2D trend maps such as are illustrated in FIG. 10, a local uncertainty range can be estimated for each simulation grid column. That uncertainty range can be derived from the kriging variance, if kriging is used to compute the trend map by interpolating between well-average property values.

For one dimensional trend curves, one uncertainty range per simulation grid layer can be estimated; that uncertainty measure can be derived from the concepts of central limit theorem, standard error and effective number of data, as a function of sample variance and number of data available. It is possible that declustered weights could be used if the curve was simply computed by averaging well property values in each simulation grid layer.

An analogous methodology could be used for three dimensional trend models, in which case one uncertainty range per simulation grid cell would be estimated, based for example on the local kriging variance if a kriging is used to compute the 3D trend model by interpolating between well data.

Such local P10/P90 values generated for 1D trend curves, 2D trend maps, or 3D trend models, can be used as a guide for modelers. Editing a curve, a map, or a 3D model, beyond the local P10-P90 range is expected to require strong geological arguments (e.g. seismic data interpretation).

It is noted that, in connection with FIGS. 10-11, it is a reasonable expectation that the edited target property average falls in the confidence interval defined in the particular location for the target property or facies proportion. If not, geomodelers may have to explain/justify their editing: what information or what rationale led geomodelers to estimate a target average value below or above the confidence interval computed from the well data. For example, if wells were drilled to reach good quality sands in a reservoir unit, then it would be reasonable for the geomodeler to set the target property average to a value lower than the P10 value computed from well data. Seismic data or geological interpretation may also be used to interpret a trend that is not clearly present in the trend curve initially computed from sparse well data, and to provide a rationale for departing from a confidence interval or otherwise adjusting a confidence interval.

Referring to FIGS. 1-11 overall, it is observed that, through use of confidence intervals and graphical feedback, geomodelers can easily define the maximum amount of smoothing consistent with well data, or assess the validity of a parametric trend model. In both cases, the smoothed curve, or the curve parametric model, should fall into the estimated confidence intervals for at least 80% of the layers (assuming P10 and P90 values are selected). More precisely, the smoothed curve, or the curve parametric model, should be under the P10 value for less than 10% of the layers, and above the P90 value for less than 10% of the layers, unless the geomodeler has information or proposes a rationale that would lead to ignore that rule.

Furthermore, as the modeler edits trend values, corresponding percentiles can also be computed from local uncertainty ranges. The resulting percentile curve, map, or 3D property, can be used by project reviewers to understand how much manual editing was performed by a geomodeler.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A computer-based method for trend modeling of subsurface properties, the method comprising:
defining a stratigraphic grid of a subsurface volume, the stratigraphic grid including a plurality of columns and a plurality of layers;
determining an initial average property value for each of the plurality of columns and plurality of layers and a confidence interval around that initial average property value defining a range of likely values for a modeled target average property value for each column or each layer around the initial average property value; receiving one or more edits to the initial average property value in some layers or columns, the one or more edits resulting in the modeled target average property value; and
determining whether the modeled target average property value falls within the confidence interval.

2. The method of claim 1, wherein the initial average property value is based at least in part on a known value in the corresponding layer or column.

3. The method of claim 2, wherein the known value is based on well data collected from a plurality of wells in the subsurface volume.

4. The method of claim 1, further comprising, upon determining that the modeled target average property value is outside the confidence interval, generating a notification that the modeled target average property value is outside the confidence interval.

5. The method of claim 4, further comprising requesting a reason why the modeled target average property value is outside the confidence interval.

6. The method of claim 4, wherein a graphical interface displays the trend model, and color codes are used to indicate if the modeled target average property value is outside the confidence interval in one or more of the plurality of layers or plurality of columns.

7. The method of claim 4, wherein a percentile corresponding to a relative position of the modeled target average property value with respect to the confidence interval is computed for each layer or each column in the model, and displayed in a graphical interface.

8. The method of claim 1, wherein the modeled target average property value comprises a facies proportion in a region of the subsurface volume.

9. The method of claim 1, wherein the confidence interval is based on a range of values derived from well data in the subsurface volume.

10. The method of claim 9, wherein the confidence interval represents a range of values for a facies proportion in a region of the subsurface volume.

11. The method of claim 1, wherein the initial average property value for each layer or column is computed as an average of known values in that layer or column within the subsurface volume.

12. The method of claim 11, wherein the confidence interval for each layer or column is computed using a t-distribution or a Gaussian distribution from the known values in that layer or column within the subsurface volume.

13. The method of claim 11, wherein the property is discrete and the confidence interval for each layer or column is computed using a Clopper-Pearson method from the known values in that layer or column within the subsurface volume.

14. The method of claim 1, wherein determining an average property value for at least one of the plurality of columns where no well data is present, includes interpolating values from nearby columns that include well data.

15. The method of claim 14, wherein kriging is used to interpolate values from nearby columns that include well data, and the confidence interval is computed from the kriging variance.

16. The method of claim 1, wherein the computation of the initial average property value and/or the confidence interval accounts for declustering weights applied to the known well data.

17. The method of claim 1, wherein the confidence interval is determined for each layer or each column in the model.

18. The method of claim 1, wherein the confidence interval corresponds to a P10 and P90 average property value range in each layer or column within the subsurface volume.

19. The method of claim 18, further comprising requesting a reason why the modeled target average property values is outside of the confidence interval corresponding to the P10 and P90 average property value range.

20. The method of claim 18, further comprising estimating that a trend model is valid if no more than 20% of the modeled target average property values are outside of the corresponding confidence interval.

21. The method of claim 18, wherein the initial trend model computed from known data is iteratively smoothed until the modeled target average property values are outside the corresponding confidence interval.

22. The method of claim 1, further comprising populating the model with property values for each layer and each column.

23. The method of claim 22, wherein populating the model with property values comprises applying a Sequential Gaussian Simulation if the property is continuous, and Multiple-Point Statistics Simulation if the property is discrete.

24. A system for trend modeling of subsurface properties, the system comprising:
a computing system including a processing unit and a memory communicatively connected to the processing unit;
a trend modeling application stored in memory and defining a stratigraphic grid of a subsurface volume, the stratigraphic grid including a plurality of columns and a plurality of layers;
wherein the modeling application is configured to, when executed:
determine an initial average property value for each of the plurality of columns and layers and a confidence interval around that initial average property value defining a range of likely values for a modeled target average property value;
receive one or more edits to the initial average property value of the subsurface volume by a user, the one or more edits resulting in the modeled target average property value; and
determine whether the modeled target average property value falls within the confidence interval.

25. The system of claim 24, wherein the one or more edits to the initial average property value includes an adjustment to the initial average property value based on a known distribution of properties in a known subsurface volume other than the subsurface volume being modeled.

26. The system of claim 24, further comprising interpolating values for the modeled property value within a column based on corresponding values for the modeled property value in a nearby column that includes well data.

27. The system of claim 26, wherein the confidence value within each column is derived from a kriging variance based on the interpolation.

28. The system of claim 24, wherein the modeling application is configured to display the trend model to a user and allow the user to edit the trend model.

29. A computer-readable storage medium including computer-executable instructions stored thereon, which, when executed by a computing system, cause the computing system to perform a method for trend modeling of subsurface properties, the method comprising:
defining a stratigraphic grid of a subsurface volume, the stratigraphic grid including a plurality of columns and a plurality of layers;
determining, an average property value for each of the plurality of columns and layers and a confidence interval around that initial average property value defining a range of likely values for a target average property value;
receiving one or more user-defined edits to the initial average property value of the subsurface volume, the one or more edits resulting in the modeled target average property value; and
determining whether the modeled target average property value falls within the confidence interval.
